(19) United States
(12) Patent Application Publication
(10) Pub. No.: US 2023/0383777 A1
(43) Pub. Date: Nov. 30, 2023

(54) EDGE CLIP

(71) Applicant: NEXANS, Courbevoie (FR)

(72) Inventors: Andreas GRUBE, MUNCHEN (DE); Robert KARAS, MUNCHEN (DE); Stefan SEGERER, SCHWANDORF (DE); Alexander REICH, WEIDEN (DE); Frank SCHROEER, Weiden (DE); Hermann TEICHER, KOHLBERG (DE); Josef KRAETZ, MÜNCHEN (DE); Frank SCHREINER, MÜNCHEN (DE)

(21) Appl. No.: 18/126,369

(22) Filed: Mar. 24, 2023

(30) Foreign Application Priority Data
Mar. 25, 2022 (EP) 22305371.1

(51) Int. Cl. F16B 2/22

(52) U.S. Cl. CPC F16B 2/22

(57) ABSTRACT

An edge clip (100) has opposite first and second legs (102, 104) interconnected by a bridge (106). The edge clip (100) has a verification means (120) for verifying correct mounting of the edge clip (100) on an edge (10), which verification means can only be attached to the edge clip (100) or be brought into an end position which indicates correct mounting of the edge clip (100), when the first and second legs (102, 104) of the edge clip (100) overlap the edge (10) for a predetermined minimum distance, and/or which forces the edge clip (100) into a correct mounting position when the verification means (120) is being brought into the end position.

### RELATED APPLICATION

This application claims the benefit of priority from European Patent Application No. 22 305 371.1, filed on Mar. 25, 2022, the entirety of which is incorporated by reference,

### FIELD

The present invention relates to fixing means, in particular to edge clips, i.e., clips that are mounted on protruding edges of structures.

### BACKGROUND

Media-carrying or electrical lines are used in all industrial domains. In many applications these media-carrying or electrical lines must be securely attached to a mechanical structure in specific ways and/or along predetermined paths and installation positions. Such attachment can be achieved by using ducts or clamps. Ducts may be assembled from standard parts that are combined along a desired path, or may be parts that have a specific shape which is adapted to the structure they are attached to. Specifically shaped parts are comparatively expensive by themselves, and any change thereto, e.g., for adding or modifying an attachment point, further significantly increases the cost. Clamps may provide a less expensive alternative.

Some applications require a verifiable proof of proper fixation or attachment of a media-carrying or electrical line. While a specifically shaped duct may provide such proof by design, clamps require additional process steps to fulfil the requirement, e.g., optical inspection by machine or a supervisor. So far, only clamps fixed by screws are considered compliant with the verifiable-proof requirement.

However, depending on the installation position of a clamp, an optical or other type of inspection of the correct mounting of a clamp may not always be possible, e.g., due to its installation position. Further, fixing clamps by screws requires a corresponding hole in the structure, which may weaken the structure and may compromise coatings such as anti-corrosion coatings and the like.

Clamps may be mounted with edge clips, which normally do not weaken a structure they are attached to, and may be designed so as not to compromise coatings. However, there is currently no process that provides a verifiable proof of proper fixation of an edge clip.

### SUMMARY OF THE INVENTION

It is, thus, desirable to provide an edge clip that enables providing verifiable proof of proper fixation or installation.

This object is achieved by the edge clip of claim 1. Advantageous embodiments and developments are provided in the dependent claims.

An edge clip according to the invention has opposite first and second legs interconnected by a bridge. The edge clip comprises a verification means for verifying correct mounting of the edge clip on an edge or rib. The verification means can only be attached to the edge clip, can only be brought into an end position which indicates correct mounting of the edge clip on the edge or rib, and/or which is visible or tangible only when the first and second legs of the edge clip overlap the edge or rib for a predetermined minimum distance. Additionally, or alternatively, the verification means forces the edge clip into a correct mounting position on the edge or rib when the verification means is being brought into the end position indicating correct mounting of the edge clip on the edge or rib.

The verification means may provide a visual, tactile or haptic feedback of the correct mounting of the edge clip. Haptic feedback may be provided by a resistive force occurring when the verification means is in the end position. The resistive force may be a resistive torque or a hard abutment. Alternatively, haptic or tactile feedback may be provided by a surface of a push pin being flush with a surrounding area, or by a visible or tangible feature that appears only when the edge clip is correctly mounted on the edge or rib. In the first case, the push pin may also provide audible feedback when reaching its end position, e.g., when a snap hook engages.

In one or more embodiments of the edge clip a bore hole extends from the bridge parallel to the first leg. The bore hole, which is open to the inside of the first leg, is adapted to receive a verification means. The verification means may engage with the side wall of the edge or rib or a structure formed therein.

In one or more embodiments of the edge clip a bore hole adapted to receive a verification means extends from the bridge parallel to the first leg. The edge clip further comprises a pivotable part having a first section protruding into the space between the first and second legs of the edge clip, and further having a second section with a structure that is adapted to receive a part of the verification means. The first section is arranged to engage with a rim of an edge when the edge clip is mounted thereon, and to pivot the pivotable part while the edge clip is brought into a correct mounting position. The structure of the second part is pivoted into alignment with the bore hole when the edge clip is in a correct mounting position, and permits the receiving the part of the verification means in this position. The pivotable part may further be adapted to prevent bringing the verification means into an end position indicating correct mounting of the edge clip while the edge clip is not in a correct mounting position. This may, for example, be achieved by a blocking element that engages with the edge or rib and permits movement, in particular a rotation, of the verification means into the end position unless the edge clip is brought into a correct mounting position. The pivotable part may be an integral part of the edge clip.

The verification means may be a screw or a push rivet.

In one or more embodiments the thread of a screw as verification means may engage with the side wall of the edge or rib through the opening in the bore hole, and may provide haptic feedback when the head of the screw abuts against the bridge, which corresponds to the end position of the verification means. The screw may also force the edge clip into the correct mounting position, and provide haptic feedback only when reaches the end position. The haptic feedback in this case may be a blocking of further turns of the screw.

In one or more embodiments with a push rivet as verification means the push rivet may have a protrusion that is arranged on an outer surface of a flexible outer section of the push rivet. When the edge clip is properly positioned on the edge or rib, the protrusion of the push rivet may be pushed outwards, through the opening in the bore hole, into a recess in the edge or rib by a push pin pushing a part of the outer section outwards. This will only be possible when the edge clip is in a correct mounting position, and the push pin will only attain a flush position with a surrounding area when it can be fully pushed into the push rivet.

In one or more embodiments of the edge clip the edge clip and/or the verification means is made from plastic.

In one or more embodiments of the edge clip a metal bracket is inserted between the opposite first and second legs. The metal bracket has protruding sections which resist a movement of the edge clip against an insertion direction. To this end the protruding sections may be resilient and protrude obliquely so as to allow and facilitate insertion and to provide some resistance against removal, e.g., by cutting into the edge or rib and locking within the cut when the edge clip is moved in a removal direction. The pivotable part may be an integral part of the metal bracket.

The edge clip in accordance with the invention provides a verifiable proof of correct installation, while being a less costly alternative to pre-formed cable ducts. The mounting process is significantly simplified over pre-formed cable ducts and classic clamps that are fixed by screws. It consists essentially of two steps: pushing the edge clip onto an edge or rib until the edge clip reaches a correct mounting position, and operating the verification means to bring it into an end position. Applications of the inventive edge clip include, but are not limited to automotive, aerospace and the like.

Various attachments, e.g., cable clamps, openings for attaching cable straps and the like, may be added to the edge clip in a generally known manner, e.g., by moulding the attachment together with the edge clip, or by attaching it to an attachment structure provided on the edge clip.

### BRIEF DESCRIPTION OF THE DRAWINGS

In the following section the invention will be discussed with reference to the drawings, in which

FIG. 1 shows an exemplary prior art edge clip with a cable clamp,

FIG. 2 shows an exemplary edge clip according to a first embodiment of the invention,

FIG. 3 shows a see-through drawing of the exemplary edge clip of FIG. 2,

FIG. 4 shows a drawing of the exemplary edge clip of FIG. 2 mounted on an edge or rib,

FIG. 5 shows a picture of the exemplary edge clip of FIG. 2 mounted on an edge or rib,

FIG. 6 shows a picture of the edge or rib after removing the edge clip of FIG. 2,

FIG. 7 shows an exemplary edge clip according to a second embodiment of the invention,

FIG. 8 shows a detail of the edge clip of FIG. 7,

FIG. 9 shows the edge clip of FIG. 7 with a pivotable part in a position permitting inserting the verification means,

FIG. 10 shows pictures of a first variant of the edge clip of FIG. 7,

FIG. 11 shows pictures of a second variant of the edge clip of FIG. 7, and

FIG. 12 shows an exemplary edge clip according to a third embodiment of the invention.

In the figures, identical or similar elements may be referenced by the same reference designators.

### DETAILED DESCRIPTION OF EMBODIMENTS

FIG. 1 shows an exemplary prior art edge clip 100 with a cable clamp 190. Edge clip 100 has opposite first and second legs 102, 104, which are interconnected by a bridge 106. A metal bracket 108 is inserted between the first and second legs 102, 104 of the edge clip 100. Metal bracket 108 has protruding sections 110, which engage with an edge (not shown) when the edge clip 100 is installed thereon. Cable clamp 190 is moulded onto the second leg 104 of the edge clip.

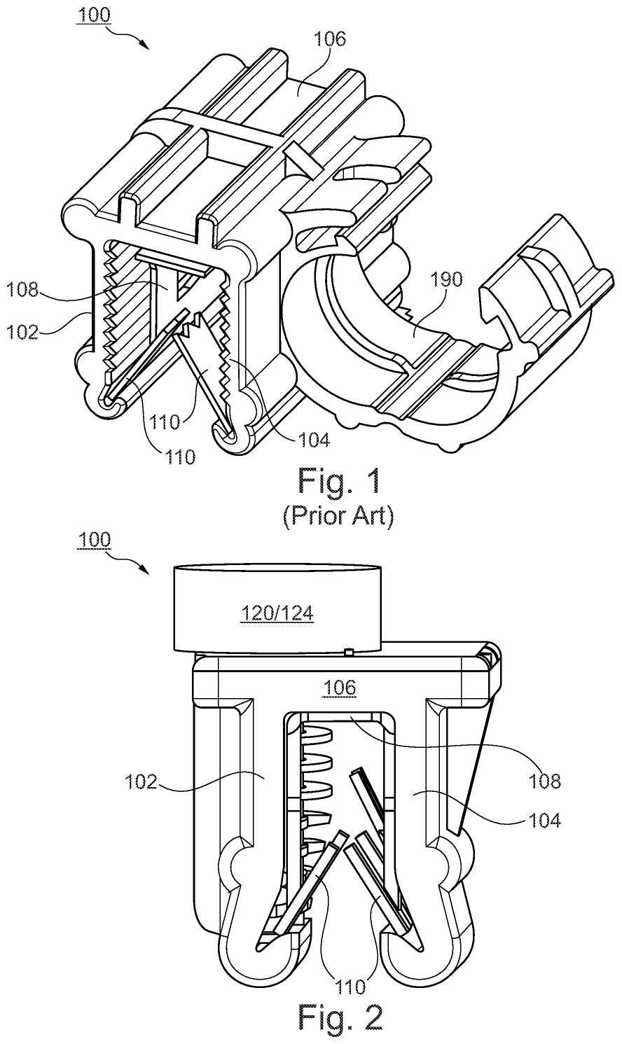

FIG. 2 shows an exemplary edge clip 100 according to a first embodiment of the invention. Edge clip 100 has opposite first and second legs 102, 104, which are interconnected by a bridge 106. A metal bracket 108 is inserted between the first and second legs 102, 104 of the edge clip 100. Metal bracket 108 has protruding sections 110, which engage with an edge (not shown) when the edge clip 100 is installed thereon. A bore hole (not visible in the figure) extends from the bridge 106 parallel to the first leg 102. The bore hole is open to the inside of the first leg 102. A verification means 120, here a screw 124, is received in the bore hole, and the thread of the screw 124 protrudes through the opening of the bore hole on the inside of the first leg 102. The thread may engage with a side wall of an edge (not shown in the figure), when the edge clip is mounted on the edge. The screw 124 serves as verification means when the screw head abuts the top side of the bridge and cannot turn any further. Verification may be had by a torque exceeding a pre-set value. If the edge clip 100 is initially not correctly mounted on the edge, turning the screw will force the edge clip further onto the edge, until the edge clip 100 is correctly mounted.

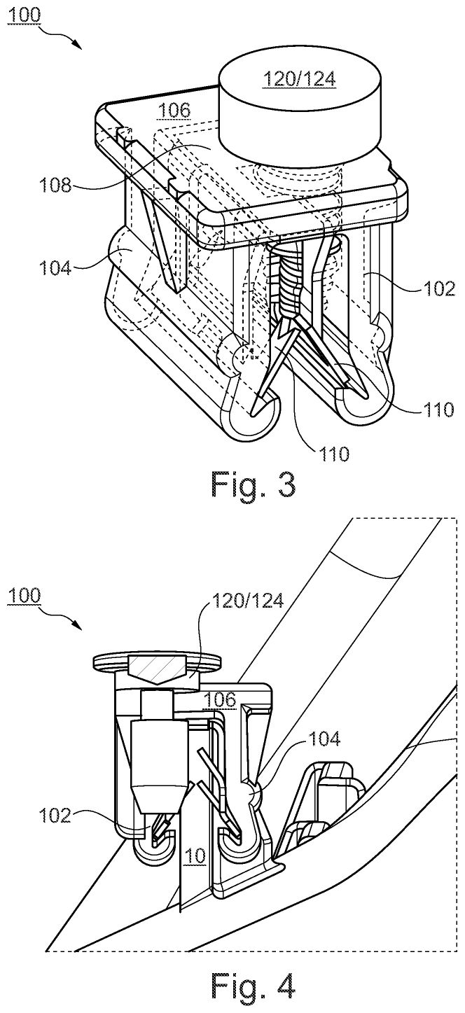

FIG. 3 shows a see-through drawing of the exemplary edge clip 100 of FIG. 2. The elements shown in the figure correspond to those shown and discussed with reference to FIG. 2.

FIG. 4 shows a drawing of the exemplary edge clip 100 of FIG. 2 mounted on an edge or rib 10. The drawing shows in particular how the thread of screw 124 engages with a side wall of the edge or rib 10.

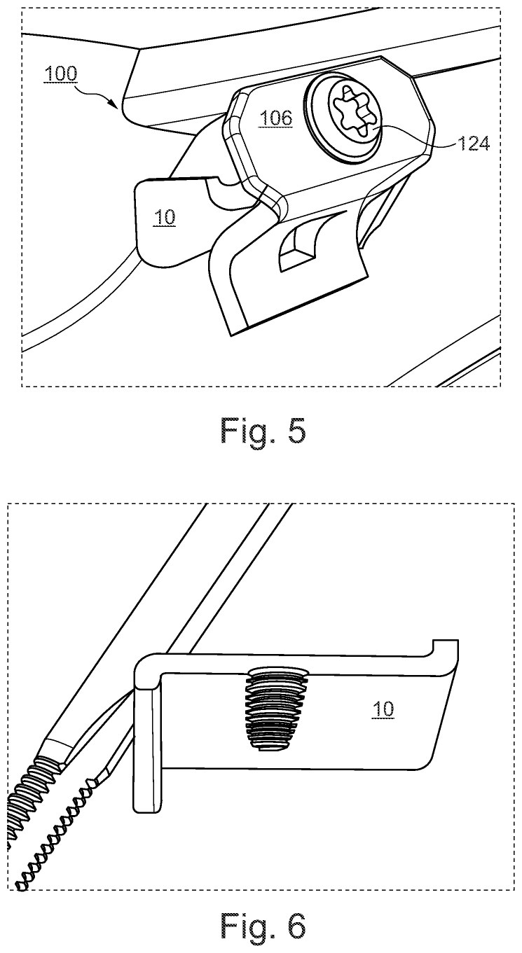

FIG. 5 shows a picture of the exemplary edge clip 100 of FIG. 2 mounted on an edge or rib 10. Screw 124 is turned tight and the increasing torque when the screw head abuts the top side of bridge 106 of edge clip 100 can be used as a verifiable proof that the edge clip 100 is securely and correctly mounted on edge or rib 10.

FIG. 6 shows a picture of the edge after removing the edge clip 100 of FIG. 2. The marks left behind on a side wall of edge or rib 10 by the thread of screw 124 are clearly visible.

FIG. 7 shows an exemplary edge clip 100 according to a second embodiment of the invention. Edge clip 100 has opposite first and second legs 102, 104, which are interconnected by a bridge 106. A bore hole 122, not visible in the figure but indicated by the dash-dotted line, extends from the bridge 106 parallel to the first leg 102. A pivotable part 130 is attached to the first leg 102. Pivotable part 130 has a first section 132 that protrudes into the space between the first and the second legs 102, 104. A second section 134 of the pivotable part 130 has a structure that is adapted to receive a part of the verification means 120, here a screw (not shown in the figure), when the first section 132 of the pivotable part 130 has engaged with a rim of an edge (not shown in the figure) when the edge clip 100 is mounted thereon and has been brought into the correct mounting position.

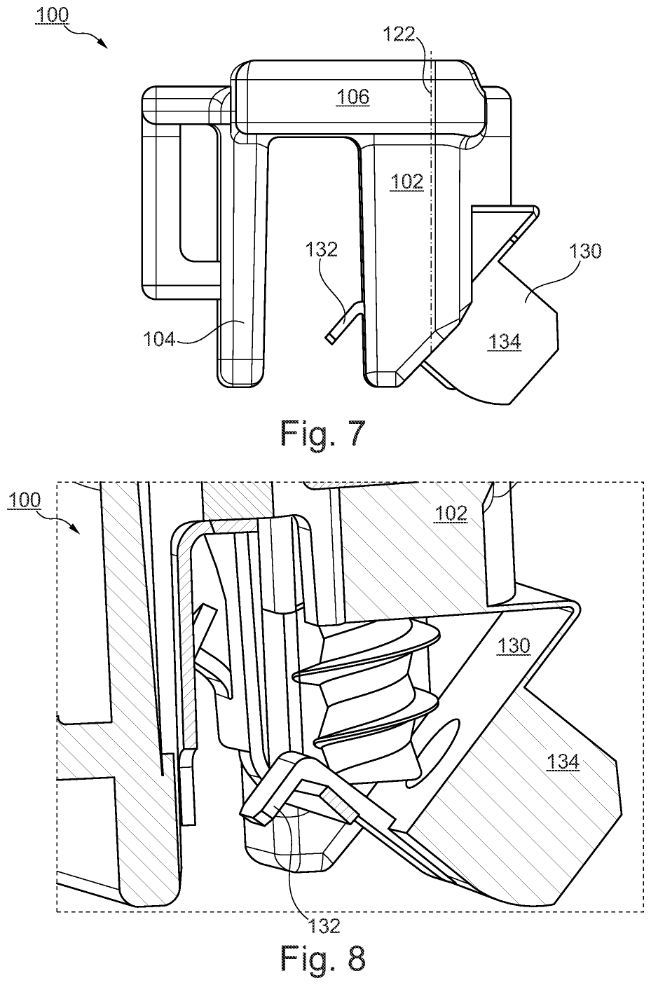

FIG. 8 shows a detail of the edge clip 100 of FIG. 7. This detail shows a thread of a screw 124 representing the verification means 120 that cannot engage with the structure of the second section 134, here a bore hole, because the pivotable part 130 is not pivoted into a suitable position, e.g., because the edge clip 100 is not correctly mounted on the edge (not shown in the figure). A verifiable proof of correct mounting of the edge clip 100 on an edge can be had when the screw 124 can be inserted into the structure of the second section 134 of pivotable part 130 and is turned tight therein.

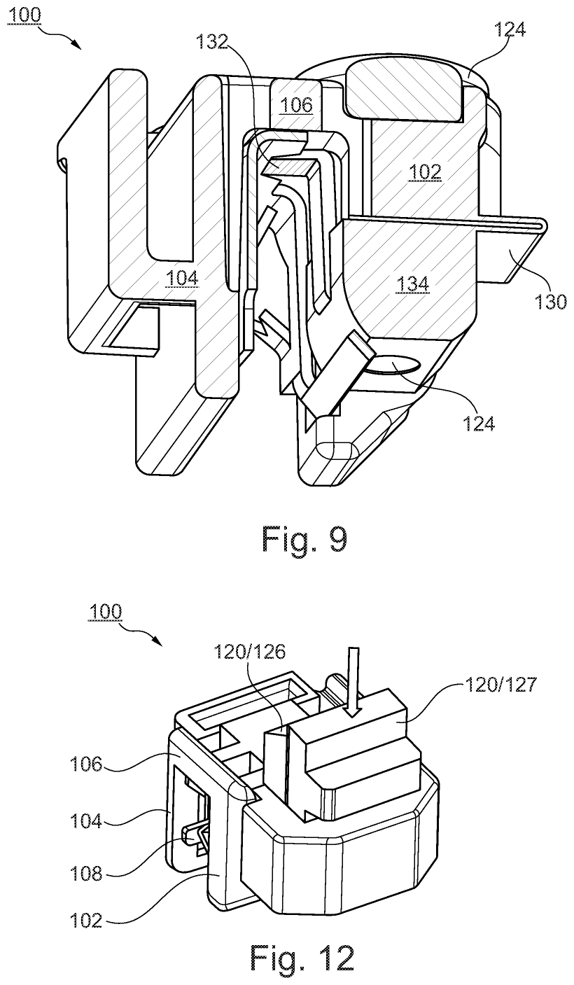

FIG. 9 shows a sectional view of the edge clip 100 of FIG. 7 with the pivotable part 130 in a position permitting inserting the verification means 120, e.g., screw 124. The figure shows how the thread of screw 124, of which only a part of the head and the very tip of the threaded part is visible, has been inserted into the structure of the second section 134 of pivotable part 130, and has been turned tight.

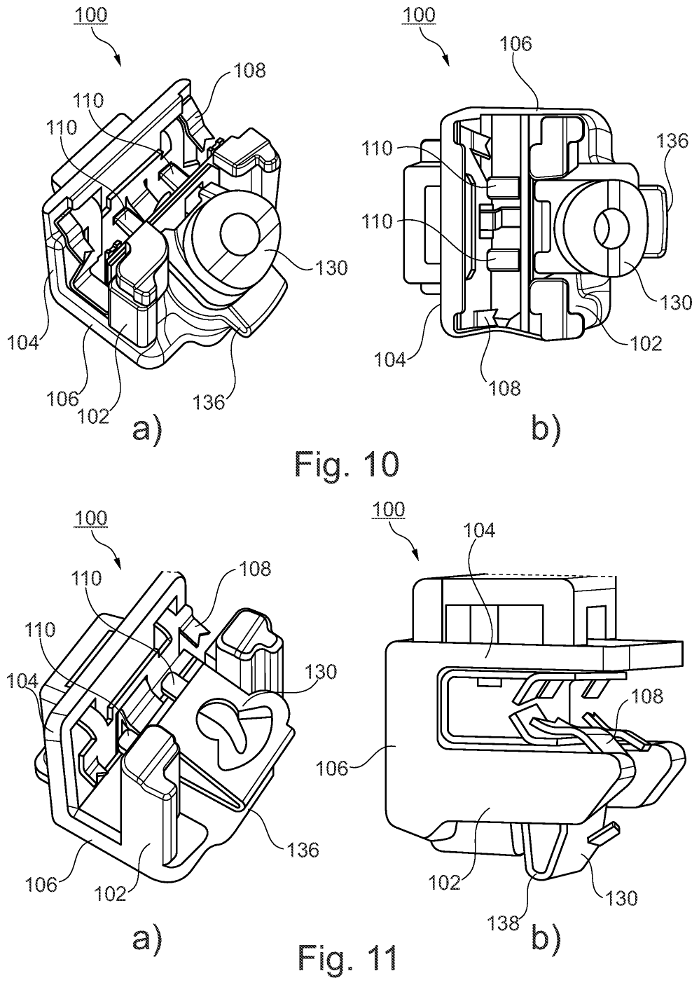

FIG. 10 a) and b) each shows a picture of a first variant of the edge clip 100 of FIG. 7. The pivotable part 130 is moulded in one piece with the bridge 106 and the first and second legs 102, 104, and is pivotable around a film hinge 136. Two prongs 110 of the first section extend into the space between the first and second legs 102, 104, and a metal bracket 108 is inserted there.

FIG. 11 a) and b) each shows a picture of a second variant of the edge clip 100 of FIG. 7. The pivotable part 130 is formed as a part of metal bracket 108, which is inserted into the space between the first and second legs 102, 104. The pivotable part 130 is resiliently pivotable around the bend 138. Two prongs 110 of the first section extend into the space between the first and second legs 102, 104.

FIG. 12 shows an exemplary edge clip 100 according to a third embodiment of the invention. The edge clip has first and second legs 102, 104, which are interconnected by a bridge 106. A metal bracket 108 is inserted into the space between the first and second legs 102, 104. The verification means 120 comprises a first part 126, which may be fixed, and a second part 127, which may be movable. The second part 127 may be pushed in the insertion direction of the edge clip 100, indicated by the arrow, only when the edge clip 100 is correctly mounted on the edge or rib 10. A step that is present between the first part 126 and the second part 127 as long as the second part 127 is not yet pushed in the insertion direction of the edge clip 100 provides a visible and haptic feedback.

LIST OF REFERENCE NUMERALS
(PART OF THE DESCRIPTION)

| | |
|---|---|
| 10 | edge/rib |
| 100 | edge clip |
| 102 | first leg |
| 104 | second legs |
| 106 | bridge |
| 108 | metal bracket |
| 110 | protruding section |
| 120 | verification means |
| 122 | bore hole |
| 124 | screw |
| 126 | first part |
| 127 | second part |
| 130 | pivotable part |
| 132 | first section |
| 134 | second section |
| 136 | film hinge |
| 190 | cable clamp |

1. An Edge clip having opposite first and second legs interconnected by a bridge, comprising:
a verification means for verifying correct mounting of the edge clip on an edge or rib, which verification means can only be attached to the edge clip, may only be brought into an end position which indicates correct mounting of the edge clip, and/or which is visible or tangible only when the first and second legs of the edge clip overlap the edge for a predetermined minimum distance, and/or which forces the edge clip into a correct mounting position when the verification means is being brought into the end position.

2. The edge clip according to claim 1, wherein a bore hole extends from the bridge parallel to the first leg, the bore hole being adapted to receive a verification means, wherein the bore hole is open to the inside of the first leg, permitting the verification means to engage with a side wall of the edge or rib or a structure formed therein.

3. The edge clip according to claim 1, wherein a bore hole extends from the bridge parallel to the first leg, the bore hole being adapted to receive a verification means, the edge clip further comprising a pivotable part, the pivotable part having a first section protruding into the space between the first and second legs, and further having a second section with a structure that is adapted to receive a part of the verification means, wherein the first section is arranged to engage with a rim of an edge or rib when the edge clip is mounted thereon, and to pivot the pivotable part while the edge clip is brought into a correct mounting position, and wherein the structure of the second part is pivoted into alignment with the bore hole when the edge clip is in a correct mounting position.

4. The edge clip according to claim 3, wherein the pivotable part is adapted to prevent bringing the verification means into an end position indicating correct mounting of the edge clip while the edge clip is not in a correct mounting position.

5. The edge clip according to claim 3, wherein the pivotable part is an integral part of the edge clip.

6. The edge clip according to claim 1, wherein the verification means is a screw or a push rivet.

7. The edge clip according to claim 1, wherein the edge clip and/or the verification means is made from plastic.

8. The edge clip according to claim 1, further having a metal bracket inserted between the opposite legs, wherein the metal bracket has protruding sections which resist a movement of the edge clip against an insertion direction.

9. The edge clip according to claim 8, wherein the pivotable part is an integral part of the bracket.

10. A method of mounting an edge clip according to claim 1, comprising:
pushing the edge clip onto an edge or rib until the edge clip reaches a correct mounting position,
operating the verification means to bring it into an end position.
